(19) United States
(12) Patent Application Publication
(10) Pub. No.: US 2013/0305182 A1
(43) Pub. Date: Nov. 14, 2013

(54) FAST ITEMIZATION OF OBJECTS

(71) Applicants: Tina Marseille, Heidelberg (DE); Lorenzo Felloni, Bad Duerkheim (DE); Holger Deist, Neckarbischofsheim (DE); Raymond Ter Linden, Waghaeusel (DE); Carsten Schmitt, Speyer (DE)

(72) Inventors: Tina Marseille, Heidelberg (DE); Lorenzo Felloni, Bad Duerkheim (DE); Holger Deist, Neckarbischofsheim (DE); Raymond Ter Linden, Waghaeusel (DE); Carsten Schmitt, Speyer (DE)

(21) Appl. No.: 13/467,773

(22) Filed: May 9, 2012

(51) Int. Cl. G06F 3/048

(52) U.S. Cl. 715/780

(57) ABSTRACT

A system and method to receive a request to specify attributes associated with a data element, and present, in response to the request, a graphical user interface layout including at least one first user interface input field for specifying a value for the attributes associated with the data element and a second user interface input field for specifying a time period to associate with the at least one first user input field.

Some business computing systems, applications, and services allow users to selectively specify and otherwise supply information to describe or complete forms, documents, and reports. In some instances, a user may be asked or required to submit a series of data entries where a portion of the data is repeated. In such instances, a user may be faced with the task of repeatedly entering the same or nearly the same data into a device, system, or user interface repeatedly.

### BRIEF DESCRIPTION OF THE DRAWINGS

FIG. 1 is an outward view of a graphical user interface layout according to some embodiments.

FIG. 2 is an outward view of a graphical user interface layout according to some embodiments.

FIG. 3A is an outward view of a graphical user interface layout according to some embodiments.

FIG. 3B is an outward view of a graphical user interface layout according to some embodiments.

FIG. 4 is a block diagram of a system according to some embodiments.

FIG. 5 is a flow diagram of a process according to some embodiments

FIG. 6 is an apparatus according to some embodiments.

### DETAILED DESCRIPTION

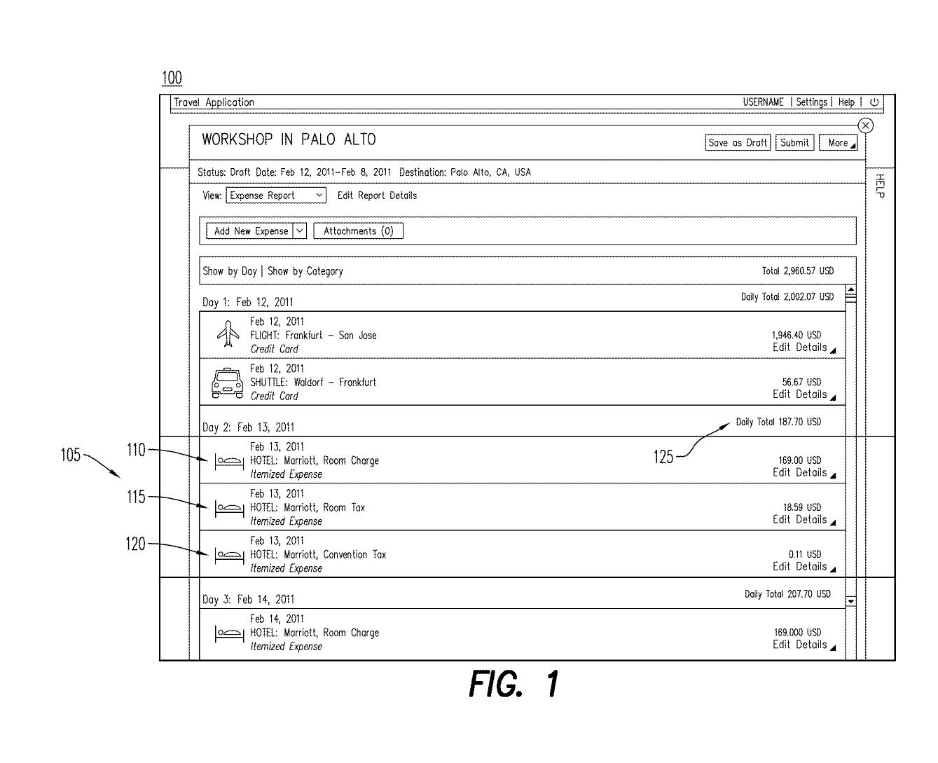

Some embodiments herein are associated with systems and methods for itemizing attributes associated with an object at a user's request. FIG. 1 is an outward view of a user interface layout or floorplan 100, reflecting an itemized expense report for a business trip encompassing multiple days (e.g., Feb. 12-18, 2011). Floorplan 100 may be an Expense Report for a user in the present example. For Feb. 13, 2011, day 2 of the trip shown at 105, in the example depicted in FIG. 1, there are three line items. The three line items include a hotel room charge 110, a hotel room tax 115, and a hotel convention tax 120 associated with the expense report for that day or particular time period. In some embodiments, the expense report may be reflected in a business object conforming to a metadata model. The line items 110, 115, 120 may represent attributes associated with the expense report business object, where each attribute has the corresponding value shown in floorplan 100.

The trip of the example of FIG. 1 encompasses more than 1 day. As such, some expenses associated with the trip may be the same for at least some of the days of the trip. For example, if the traveler associated with the example trip stayed in the same hotel for multiple days of the trip and the rate for the hotel room was constant throughout at least part of the traveler's stay, then expenses incurred for those multiple days will be the same. In this example, an expense report for the traveler would include multiple expense report entries (i.e., line items such as the hotel charges) having the same values. The traveler or other entity creating an expense report for the traveler would need to enter multiple expense report entries having the same values, a task that may be viewed as being cumbersome and inefficient.

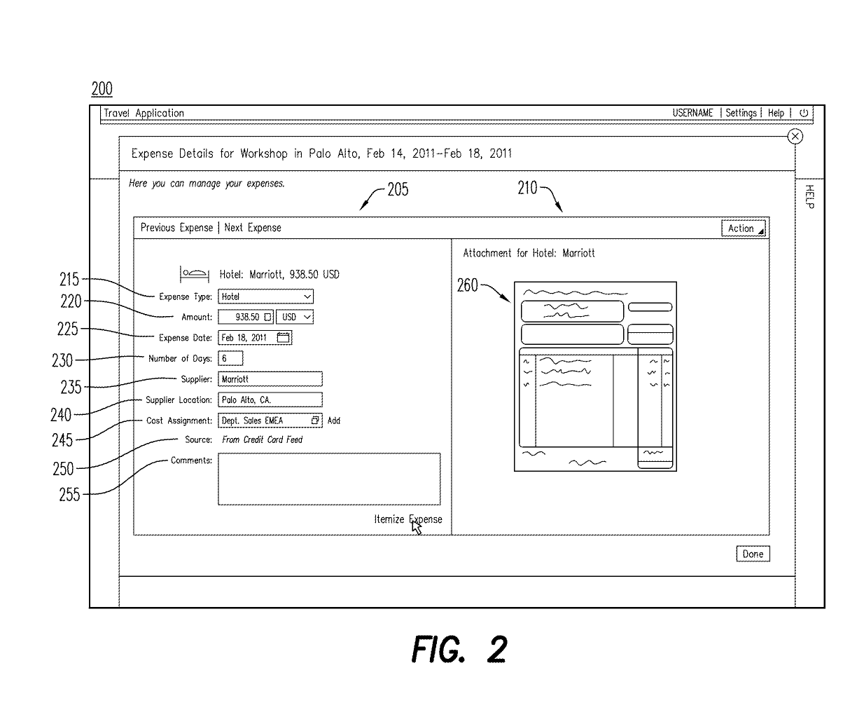

FIG. 2 is a floorplan including an expense report data entry section 205 and a receipt or other attachment display section 210. The receipt 210 is provided in an electronic format to, for example, improve record keeping and provide a point of reference for a user as they input values into the expense report in the data entry section 205. The expense report data element in FIG. 2 may be a business object as mentioned above. Attributes of the expense report may include an expense type 215, an amount for the particular expense type specified at 215, an expense date 225, a number of days of travel included in the expense 230, a supplier associated with the expense at 235, a location of the supplier 240, and a cost assignment 245 to associate with the expense. Floorplan 200 further includes an indication of the source of the data therein at user interface element 250, as we as a user input interface element for the entry of free-form comments at 255. The presentation of the receipt at 260 may facilitate a user's entry of at least some of the values in section 205. Embodiments herein are not limit to the example of FIG. 2.

In some aspects, section 205 includes a total, summary, or overview representation of the expenses related to the trip associated therewith. However, a business organization or other entity may require a business traveler to substantiate the total expenses by providing a detailed itemization of the total expenses. In some embodiments, a user may signal a request to itemize the hotel expenses shown in section 205. User interface element “Itemize Expense” 265 may be used to initiate a request to itemize an expense report, in some embodiments.

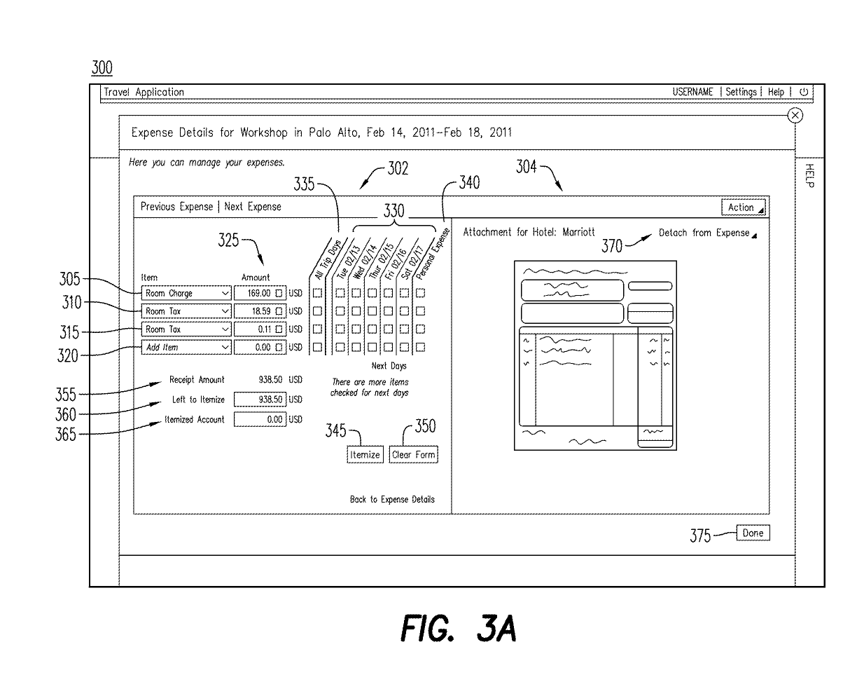

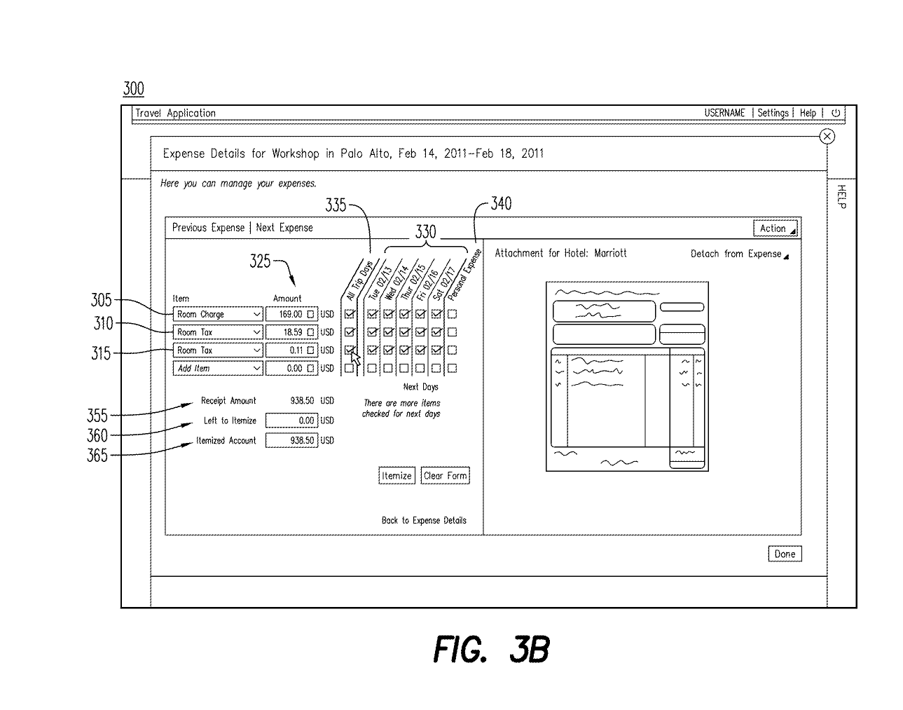

FIG. 3A illustrates an example floorplan 300. Floorplan 300 may be presented to a user on a computing device or system including a processor for implementing the methods and techniques disclosed herein. FIG. 3A continues the example expense report of FIG. 2. Floorplan 300 is presented in response to a receipt of an indication of a request to itemize expenses associated with the expense report (i.e., data element or business object instance).

Floorplan 300 includes a number of first user interface input fields for specifying values for the attributes associated with the expense report. For example, a room charge 305 may be a type of item associated with the expense report and the amount (attribute) shown at 325 may have a value of $169.00 USD. Likewise, a room tax 310 and a room tax 315 may also be specified with the corresponding expense amounts shown at in column 325. The amounts entered at 325 of section 302 may be substantiated by the attached receipt shown at 304.

Floorplan 300 includes a number of second user interface input fields 330 and 335. These second user interface input fields provide a mechanism for selecting which specific days of the business trip the expenses associated with itemized line items 305-320 are to be applied in the expense report. As an example, the room charge of $169 may be applied to every day of the trip by selecting the user interface input field at 335, the room charge may be accounted for as an expense for a sub-set (e.g., Tue, 02/13 and Wed, 02/14) of the set of days presented at 330. The example of floorplan 300 also includes a user interface element 340 for indication whether an expense is a “personal expense”.

FIG. 3B also includes the user interface layout or floorplan 300 introduced in FIG. 3A. In contrast to FIG. 3A, floorplan 300 illustrated in FIG. 3B shows the second user interface input fields that have been populated to specify the days for which the associated expenses of line items 305, 310, and 315 are applicable for the example expense report. As illustrated, the number of days include at least one day.

Floorplan 300 also includes a presentation of a receipt amount 355, indicative of the total amount stated on the attached receipt and being itemized. In some embodiments, floorplan 300 includes a presentation of an updated, current calculation of the amount of expenses still to be itemized 360 and an updated, current calculation of the total amount of itemized expenses at 365. In some embodiments, the calculations for 360 and 365 are performed automatically in response to the selection and specification of the type and amount of the incurred expense(s). In this manner, a user may be informed of the amount left to be itemized and the itemized amount within the context of floorplan 300.

In some aspects, an expense report (i.e., a particular instance of a data element) such as the expense report illustrated in FIG. 1 may be generated subsequent to a user itemizing the travel expenses, as disclosed hereinabove. Referring again to FIG. 1, the individual, itemized items 110, 115, and 120 contributing to the overall expense report are shown. While some of the itemizations may be repeated for multiple days, the embodiments herein may provide a mechanism to efficiently and quickly specify the itemizations.

In some embodiments, documents such as a receipt may be processed by optical character recognition (OCR) or other processes to render the document into a machine-readable data format. The OCR derived data may be used to automatically generate, suggest, or propose itemization entries for a data element. In some aspects, the generated, suggested, or proposed entries may be accepted, revised, or rejected by a user or other entity, in part or in full.

In some aspects, a method and system herein may provide a notification to a user or a machine in the event that an itemization or other data element attribute specification process violates a rule, limit, or constraint. In some embodiments for example, a notification may be generated when a specific value for a particular line itemization exceeds or violates a related rule. Such notifications may be generated and transmitted to a local or remote device or system.

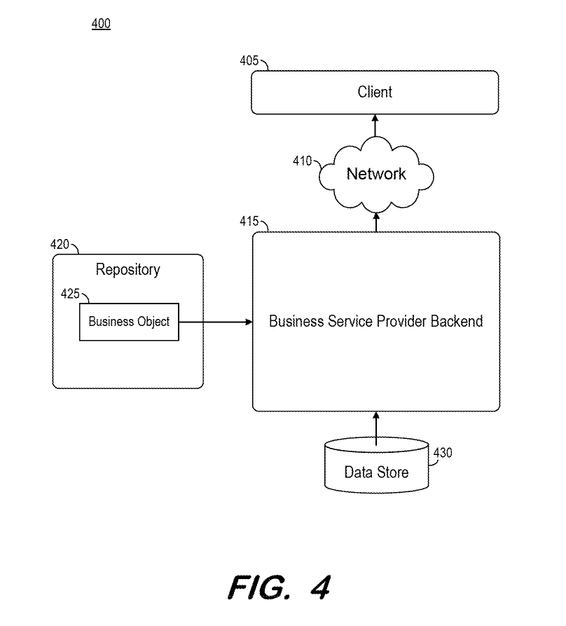

FIG. 4 represents a logical architecture for describing processes according to some embodiments, and actual implementations may include more or different components arranged in other manners. Other topologies may be used in conjunction with other embodiments. Moreover, each system described herein may be implemented by any number of computing devices in communication with one another via any number of other public and/or private networks. Two or more of such computing devices of may be located remote from one another and may communicate with one another via any known manner of network(s) and/or a dedicated connection using one or more communication protocols. Each computing device may comprise any number of hardware and/or software elements suitable to provide the functions described herein, as well as any other functions. For example, any computing device used in an implementation of system 400 may include a processor to execute program code such that the computing device operates as described herein.

All systems and processes discussed herein may be embodied in program code stored on one or more computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

System 400 includes business service provider backend 415 for providing business services to users or consumers (not shown) of system 400. The users may interact with system 400 through client device 405 over a network 410. In some aspects, business service provider backend 415 may store user information into and retrieve customer information from physical tables of data store 430. Business service provider backend 415 may provide one or more services and solutions to users thereof. In some aspects, a number of services may be integrated by business service provider backend 415 to provide a comprehensive business solution to users.

Data stored in data store 430 may be received from disparate hardware and software systems, including some that may not be interoperational with one another. The systems herein may include a back-end data environment employed in a business or industrial context. The data may be pushed to data store 430 and/or provided in response to queries received therefrom.

The data of data store 430 may reside in a physical database or stored in-memory (e.g., in Random Access Memory). The data may comprise a relational database, an in-memory database, a multi-dimensional database, an eXtendable Markup Language (XML) document, and/or any other structured data storage system. The physical tables of data store 430 may be distributed among several relational databases, dimensional databases, and/or other data sources. To provide economies of scale, data store 430 may include data of more than one user. Business service provider backend 415 may include mechanisms to ensure that a client accesses only the data that the client is authorized to access. Moreover, the data of data store 430 may be indexed and/or selectively replicated in an index to allow fast retrieval thereof.

The structures of and relationships between the physical database tables may be complex, and business object models (referred to henceforth as “business objects”) may be used to shield developers and end-users from these complexities. System 400 implements metadata models to support different business solutions. Metadata models may include generic models of a business object, a floorplan (i.e., a user interface layout), user interface text, a process component, and a message type, among others. A business object, for example, is a software model data structure representing real-world items used during the transaction of business and having associated attributes. An instance of a business object metadata model (i.e., a particular data set according to the business object metadata model) may comprise, for example, an Expense Report object model. Instances of this object model, in turn, represents specific data (e.g., ExpenseReport 5985) and provide a mapping to the underlying tables storing the specific data associated with a particular travel request and expense report.

Repository 420 includes metadata of various metadata models (e.g., business objects). These metadata models include metaobjects and instances of the metaobjects, referred to herein as object models or objects. The metaobjects and object models are defined by metadata of repository 420.

As mentioned above, the metaobjects may include generic models of a floorplan (also referred to herein as a graphical user interface layout), a business object, a user interface text, a process component, and a message type, but embodiments are not limited thereto. The metaobjects and object models may be embodied in any type of data structure, including but not limited to eXtensible Markup Language files. As in the conventional storage of object instance data, the metadata defining the specific metaobjects and object models may be stored in database tables and/or any other suitable format.

Business object 425 is an object model, or class. The metadata of business object 425 may therefore provide information regarding the structure and attributes of the data of instances of business object 425. Accordingly, backend 410 uses the metadata to access corresponding data of data store 430.

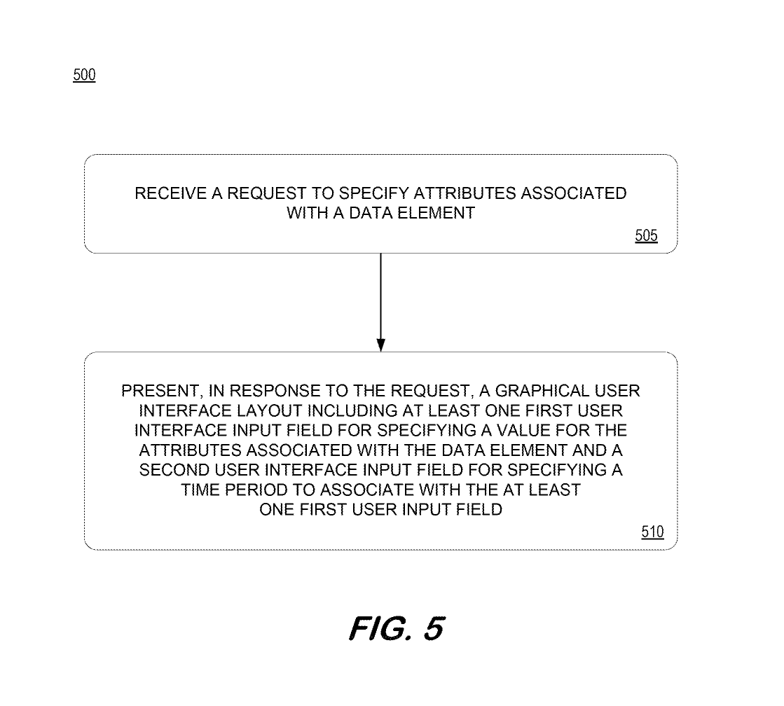

FIG. 5 is an example of a flow diagram of a process 500, according to some embodiments herein. At operation 505, a request is received to specify attributes associated with a data element. In some embodiments herein, the data element may be an instance of a business object as described above. The request may be received from a user via a graphical user interface layout or floorplan. In some aspects, a user interacting with the user interface layout need not be aware of the underlying data structure corresponding to the data element associated with the request or its storage location. For example, the floorplan may present a list of one or more data elements (e.g., expense reports type of business objects) that the user may select from for the purpose of requesting that the attributes of the expense report be itemized, in the course of performing business related functions (e.g., generating a travel expense report using a travel management service). The list of data elements may represent a report, a document (structured and unstructured data), and other objects.

At operation 510, in response to receiving the request from operation 505, a graphical user interface layout including at least one first user interface input field for specifying a value for the attributes associated with the data element and a second user interface input field for specifying a time period to associate with the at least one first user input field may be presented. In some aspects, the first user interface input fields may facilitate the entry and specification of a value(s) for at least one attribute of the data element being further defined by process 500. As an example, the first user interface input fields may refer to a type of line item (e.g., hotel room charge, hotel room tax, airline ticket, etc.) and a value for the line item. In some aspects, the second user interface input fields for specifying a time period to associate with the at least one first user input field may include a user interface element for selecting one or more days, months, years, or other periods of time.

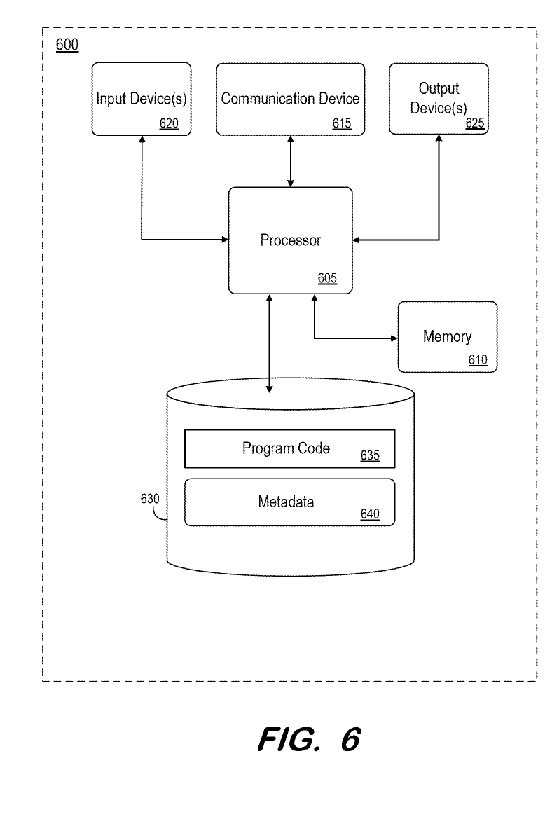

FIG. 6 is a block diagram of apparatus 600 according to some embodiments herein. Apparatus 600 may comprise a general-purpose computing apparatus and may execute program code to perform any of the functions and processes described herein. Apparatus 600 may comprise an implementation of one or more elements of system 400, including in some embodiments aspects of business service provider 415 and/or of a client device 405 on which the user interfaces and diagrams of the present description are presented. Apparatus 600 may include other unshown elements according to some embodiments.

Apparatus 600 includes processor 605 operatively coupled to communication device 615, data storage device 630, one or more input devices 620, one or more output devices 625 and memory 610. Communication device 615 may facilitate communication with external devices. Input device(s) 620 may comprise, for example, a keyboard, a keypad, a mouse or other pointing device, a microphone, knob or a switch, an infra-red (IR) port, a docking station, and/or a touch screen. Input device(s) 620 may be used, for example, to enter information into apparatus 600. Output device(s) 625 may comprise, for example, a display (e.g., a display screen) a speaker, and/or a printer.

Data storage device 630 may comprise any appropriate persistent storage device, including combinations of magnetic storage devices (e.g., magnetic tape, hard disk drives and flash memory), optical storage devices, Read Only Memory (ROM) devices, etc., while memory 660 may comprise Random Access Memory (RAM).

Program code 635 of data storage device 630 may be executable by processor 605 to provide any of the functions and processes described herein. Embodiments are not limited to execution of these functions by a single apparatus. Metadata 640 may include metadata of reports (e.g., expense reports) and data sources as described herein. Data storage device 630 may also store data and other program code for providing additional functionality and/or which are necessary for operation thereof, such as device drivers, operating system files, etc.

Embodiments have been described herein solely for the purpose of illustration. Persons skilled in the art will recognize from this description that embodiments are not limited to those described, but may be practiced with modifications and alterations limited only by the spirit and scope of the appended claims.

What is claimed is:

1. A method implemented by a computing system in response to execution of program code by a processor of the computing system, the method comprising:
receiving a request to specify attributes associated with a data element; and
presenting, in response to the request, a graphical user interface layout including at least one first user interface input field for specifying a value for the attributes associated with the data element and a second user interface input field for specifying a time period to associate with the at least one first user input field.

2. The method of claim 1, wherein the time period is a set of days including at least one day and the second user interface input field includes a user interface element for specifying which of the days in the set applies for the at least one first user interface input field.

3. The method of claim 2, wherein the second user interface element provides a mechanism to select one, all, and a sub-set of the set of days to associate with the at least one first user interface input field.

4. The method of claim 1, wherein the user interface layout includes a presentation of an updated calculation of a first value associated with the data element, the first value being updated based on the value specified by the at least one first user interface input field for attributes associated with the data element.

5. The method of claim 1, wherein the data element is an instance of a business object metadata model.

6. The method of claim 1, further comprising:
receiving data derived from an optical character recognition process of a document; and
automatically proposing at least some of the received data as inputs for at least one of the at least one first user interface input field and the second user interface input field.

7. The method of claim 1, further comprising presenting a report including the value specified for the at least one first user interface input field for the time period specified by the second user interface input field.

8. A non-transitory medium storing processor-executable program code, the medium comprising:
program code to receive a request to specify attributes associated with a data element; and
program code to present, in response to the request, a graphical user interface layout including at least one first user interface input field for specifying a value for the attributes associated with the data element and a second user interface input field for specifying a time period to associate with the at least one first user input field.

9. The medium of claim 8, wherein the time period is a set of days including at least one day and the second user interface input field includes a user interface element for specifying which of the days in the set applies for the at least one first user interface input field.

10. The medium of claim 9, wherein the second user interface element provides a mechanism to select one, all, and a sub-set of the set of days to associate with the at least one first user interface input field.

11. The medium of claim 8, wherein the user interface layout includes a presentation of an updated calculation of a first value associated with the data element, the first value being updated based on the value specified by the at least one first user interface input field for attributes associated with the data element.

12. The medium of claim 8, wherein the data element is an instance of a business object metadata model.

13. The medium of claim 8, further comprising:
program code to receive data derived from an optical character recognition process of a document; and
program code to automatically propose at least some of the received data as inputs for at least one of the at least one first user interface input field and the second user interface input field.

14. The medium of claim 8, further comprising presenting a report including the value specified for the at least one first user interface input field for the time period specified by the second user interface input field.

15. A system comprising:
a computing device comprising:
a memory system storing processor-executable program code; and
a processor to execute the processor-executable program code in order to cause the computing device to:
receive a request to specify attributes associated with a data element; and
present, in response to the request, a graphical user interface layout including at least one first user interface input field for specifying a value for the attributes associated with the data element and a second user interface input field for specifying a time period to associate with the at least one first user input field.

16. The system of claim 15, wherein the time period is a set of days including at least one day and the second user interface input field includes a user interface element for specifying which of the days in the set applies for the at least one first user interface input field.

17. The system of claim 15, wherein the user interface layout includes a presentation of an updated calculation of a first value associated with the data element, the first value being updated based on the value specified by the at least one first user interface input field for attributes associated with the data element.

18. The system of claim 15, wherein the data element is an instance of a business object metadata model.

19. The system of claim 15, wherein the processor further executes the processor-executable program code in order to cause the computing device to:
receive data derived from an optical character recognition process of a document; and
automatically propose at least some of the received data as inputs for at least one of the at least one first user interface input field and the second user interface input field.

20. The system of claim 8, further comprising presenting a report including the value specified for the at least one first user interface input field for the time period specified by the second user interface input field.
